(19) United States
(12) Patent Application Publication
(10) Pub. No.: US 2005/0177875 A1
(43) Pub. Date: Aug. 11, 2005

(54) Revocation of content material

(76) Inventors: Franciscus Lucas Antonius Johannes Kamperman, Eindhoven (NL); Antonius Adriaan Maria Staring, Eindhoven (NL)

Correspondence Address: Corporate Patent Counsel;Philips Electronics North America Corporation, P O Box 3001, Briarcliff Manor, NY, 10510, US

(21) Appl. No.: 10/509,408

(22) PCT Filed: Feb. 26, 2003
(86) PCT No.: PCT/IB03/00803

(30) Foreign Application Priority Data
Mar. 28, 2002 (EP) 02076209.2

(51) Int. Cl. H04K 1/00

(52) U.S. Cl. 726/27; 705/51

(57) ABSTRACT

This invention relates to attaching or relating a unique identifier of an importing/screening device to content material during import from a non-compliant domain into a compliant domain. In this way, it is always possible to identify the importing device for a given content material. A list comprising unique identifiers for importing devices that has been determined to import content material illegally may then be used in devices, applications, systems, etc. for the using content material in such a way that the use may be prohibited for content material being imported in to the compliant domain by devices, applications, systems, etc. that has been determined to import content material illegally. This allows for the revocation of use of content material in the compliant domain that has been imported there byan importing/screening device that has been determined to illegally import content material.

This invention relates to the field of consumer electronics, and in particular to screening techniques for copy-protected material.

Digital recordings have the unique property that copies of content material have the same quality as the original. Therefore the need for an effective copy-protection scheme is particularly crucial for the protection of content material that is digitally recorded. A number of protection schemes have been developed or proposed that record the content material in an encrypted and/or marked form. Other protection schemes have been developed or proposed that record a cryptographic key that controls the use, access, playback and/or rendering of the content material. Devices, systems, applications, etc. may be divided up into compliant and non-compliant devices, systems, applications, etc. (denoted devices in the following). Compliant devices are devices which comply with a given set of certain rules, e.g. with respect to copy, access, playback, and/or rendering rules, while non-compliant devices do not comply fully or partly with that particular set of rules. It is usually said that compliant devices act in the compliant domain, while non-compliant devices act in the non-compliant domain.

Current content protection devices, systems, applications, etc. attempt to prevent that content material in the compliant domain ‘leaks’ into the non-compliant domain. This may be done e.g. by encrypting the content in the compliant domain. Additionally, current content protection systems also attempt to prevent that content material illegally is imported from the non-compliant domain into the compliant domain. This may be done e.g. by applying watermarking to the legal content material.

When an attempt is made to import content from the non-compliant domain into the compliant domain that content is screened by a compliant device, e.g. for the presence of a watermark and/or other information/indications regarding a legal use of the content. If the screening is ok (e.g. by having a watermark indicating that importing is ok), the content will be imported into the compliant domain. Otherwise, the import action will be refused and the content material ‘stays’ in the non-compliant domain.

When importing content, the content is screened at the border between the non-compliant domain and the compliant domain. After the content has been brought into the compliant domain it will be possible to use it, e.g. for playback, rendering, copying, etc. However, if a hacker has succeeded in hacking a device able to import content into the compliant domain, it becomes possible to illegally import content, without being able to remove this content from the compliant domain again. This is due to that a check on importing content is done ‘at the entrance’ only and not anymore after that. Once the content is in the compliant domain, it will be considered as legal and it will be possible to (illegally) use it.

One previous solution addressing this problem is to use so-called screening information, which is a (use, play, etc.) right issued by a compliant content importing device, and which presence is required to allow playback by a compliant device, system or application. However, if a hacker has succeeded in hacking a device he will also succeed in producing illegal screening information and there will be no barrier anymore to prevent illegal use, playback, etc. of the content material.

It is an object of the invention to provide a method (and corresponding system) of enabling revocation of screened/imported content material where the method (and system) solves the above-mentioned problems of the prior art.

This is achieved by a method (and corresponding system) of enabling revocation or authorization of screened content material screened by a screening device or a screening application, the method comprising the step of:
attaching or relating a unique screening device or application identifier to content material during import of the content material from a non-compliant domain into a compliant domain,
   where the identifier uniquely identifies the screening device or the screening application used to import said content material.

In this way, it is possible to identify the screening/importing device/application that was used to import a given content material. This may advantageously be used if it is determined that a given content material was imported illegally thereby giving the possibility of generating/maintaining a list, a database, etc. of import devices that has been used for illegal/illicit purposes. This list may then be supplied to or be accessible by devices, applications, systems, etc. for using content material in such a way that the use may be prohibited for content material being imported in to the compliant domain by devices, applications, systems, etc. that has been determined to import content material illegally.

Preferred embodiments of the invention are defined in the sub-claims and in the following.

The invention is explained in further detail, and by way of example, with reference to the accompanying drawing wherein:

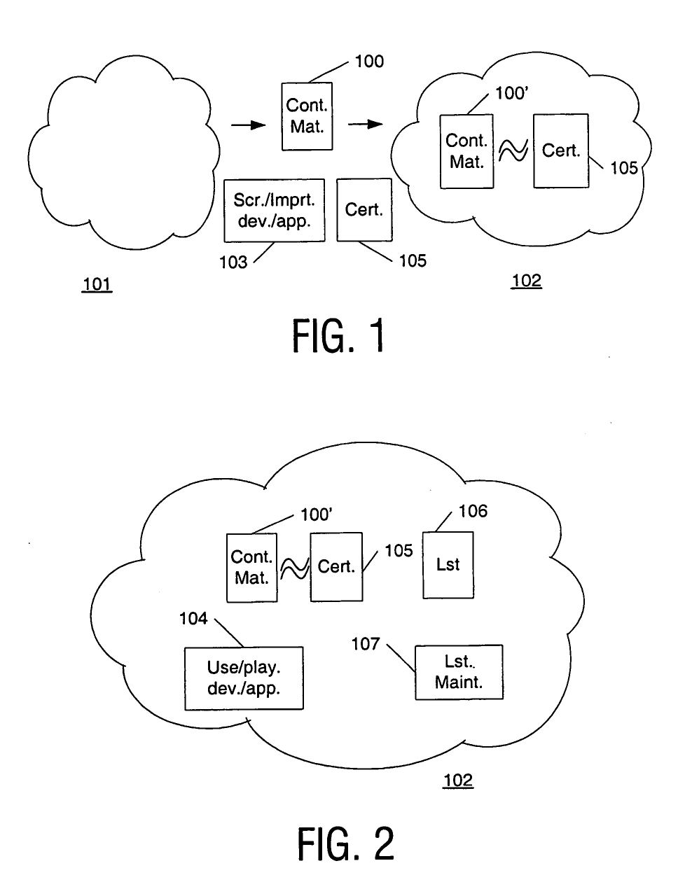

FIG. 1 illustrates the import of content material from the non-compliant domain into the compliant domain according to the present invention;

FIG. 2 illustrates the use of content material according to the present invention;

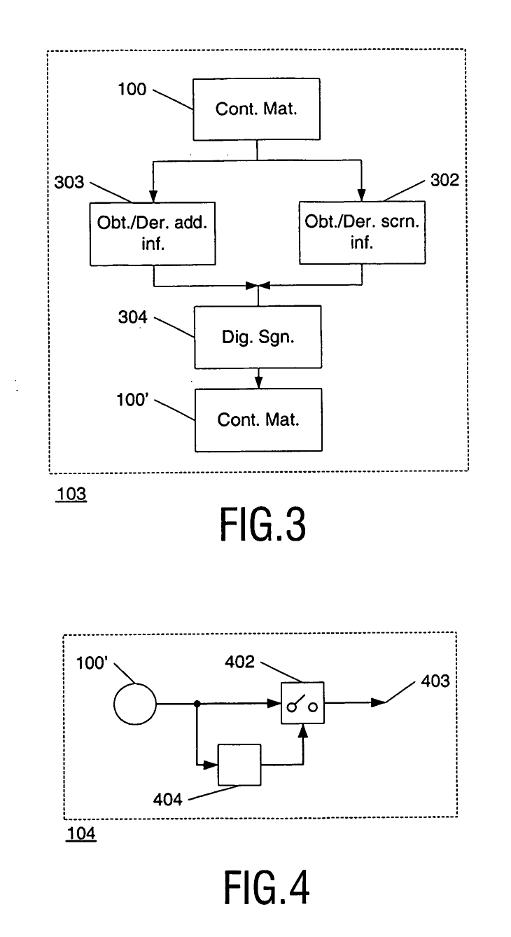

FIG. 3 illustrates a schematic block diagram of a importing/screening device/application according to the present invention;

FIG. 4 illustrates a use device/application according to the present invention,

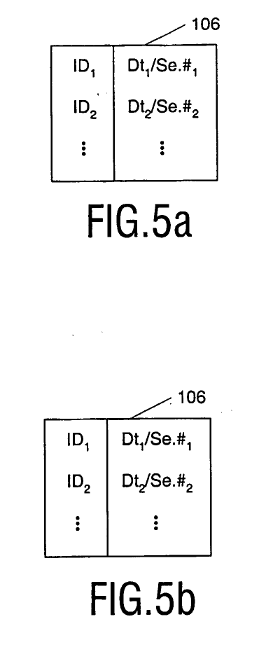

FIGS. 5a and 5b illustrate examples of formats for a revocation and an authorization list, respectively.

Throughout the drawings, the same reference numerals indicate similar or corresponding features, functions, etc.

FIG. 1 illustrates the import of content material from the non-compliant domain into the compliant domain according to the present invention. Shown is a schematic illustration of a non-compliant domain (101) and a compliant domain (102). Also shown is a content material (100), having certain rights associated with it, that is being imported from the non-compliant domain (101) into a compliant domain (102) by a screening/importing device/system/application (103) (denoted importing device in the following). Additionally, there may also be content material which will not have any explicit right(s) associated with it, will not contain a watermark, copy-bits, etc. Import of such content may be done according to a predetermined rule, e.g. to accept all such content. The importing device (103) checks whether a content material (100) should be allowed into the compliant domain (102) e.g. by checking for the presence (or absence) of one or more particular watermarks (or other identification means) signaling if import is allowed and what rights are to be associated with the content after import or according to other protection schemes. Additionally, screening information may be generated and/or obtained by the importing device. The screening information is typically one or more rights issued by a compliant content screening/importing device. The screening information may e.g. be stored in a secure side-channel, in a user inaccessible file or in a secure area, format, etc. together with other rights, if any. Alternatively, the screening information may be signed using a signature unique to the screening/importing device as explained in the following. In this way, tamper resistance is provided for the screening information. According to the present invention each importing device (103) has a unique identifier that uniquely identifies the import device (103) where the unique identifier is securely attached or related to the content material (100) during import resulting, if everything is ok, in an imported content material (100′). Typically the imported content material (100′) is also converted to an encrypted format by the screening device so that it may not be used outside the compliant domain (102). Preferably, the unique identifier is a unique serial number for the particular import device (103) used to import the content material (100) into the compliant domain (102). The imported content material (100′) may comprise the unique identifier e.g. by embedding a representation of the unique identifier in one or more watermarks. Alternatively, the imported content material (100′) is related with the unique identifier e.g. using a signature and a private/public key pair being unique to the screening device (103). Additionally, a representation of a time stamp and/or sequence number may be attached or related to the imported content in a similar manner as for the unique import device id number/serial number. This may be used to limit revocation to content that has been imported into the compliant domain after a specific moment in time (e.g. in this way it becomes possible to revoke only content that has been imported after the screen was hacked, and have content that was imported prior to the hack, when the screening was operating properly, still authorized). In a preferred embodiment, each device (103) has a screening/importing device certificate (105) e.g. signed by a trusted authority, where the certificate (105) represents the approved compliance of the importing device (103). The certificate (105) may comprise the unique identifier e.g. in the form of a serial number. Preferably, the certificate (105) also comprises a unique public key of a unique private/public key pair being unique to the specific importing device (103) that the specific certificate (105) is for. The private key of the key pair unique to the import device (103) is secret to the device and used to digitally sign the screening information and preferably additional information being dependent of at least a part the content material (100). In this way, the certificate is securely attached or related in an un-ambiguous way to the imported content material (100′).

The additional information is in a preferred embodiment a result of a hash function (or another kind of secure function) performed on at least a part of said content material (100). In this way, the additional information (and thereby the signature) becomes dependent on the content material (100), so that a valid signature for one content material may not simply be used in connection with another content material. Additionally or as an alternative, the additional information may comprise a ‘fingerprint’ of at least a part of the content, where a fingerprint is a way, like a human fingerprint, to uniquely represent the content on the basis of specific characteristics of the content. The signature may then be set over the fingerprint in addition or as an alternative.

The public key, comprised in the certificate (105) being attached or related to the content material (100) during import, may then be used by other applications, systems, devices, etc. in order to check the validity of the digital signature.

Alternatively, instead of signing the screening information, like described above, it may be encrypted or even both.

In this way, it is possible to un-ambiguously identify, for a given content material (100′) in the compliant domain (102), the identity of the import device (103) that was used to import that particular content material (100) at later times. So if a hacked device has been used to import illegal/illicit content material into the compliant domain it is possible to uniquely identify that particular hacked device when it is determined that the imported content material was imported illegally.

According to the present invention, a list, a database or the like may be generated and/or maintained that comprises the identification of importing devices that illegally have imported content material into the compliant domain. This may be used to enhance the security as explained in greater detail in connection with FIG. 2. Additionally, if a representation of a time stamp and/or sequence number was attached or related to the imported content revocation of content may e.g. be limited to content that was imported after a certain date, etc.

Alternatively, the list may comprise identification of importing devices that is authorized to import content material, effectively a white-list/authorization list of the (only) devices allowed to import content. In this case, the time-stamp or the sequence number may be used to prohibit the use of imported content material that was imported before authorization, i.e. entry in the white-list.

FIG. 2 illustrates the use of content material according to the present invention. Shown in the Figure is a compliant domain (102) comprising an already imported content material (100′) having a unique identifier (105) attached or related to it. Preferably, the unique identifier (105) is a serial number of the particular importing device used to import the content material into the compliant domain (102) or a certificate (105), e.g. signed by a trusted third party, comprising the serial number and/or a public key of the private/public key pair for the importing device. Also shown is a revocation list, database or the like (106) comprising a unique identification of all the known hacked or illegal importing devices. This unique identification preferably is the unique serial number of the importing device used or a reference to a unique private/public key pair and/or a corresponding signature generated using the private key of the unique key pair of the importing device used. Alternatively, the list (106) may be a ‘positive’ list/a white-list, i.e. a list comprising the unique serial numbers of importing devices that are exclusively authorized to import content material into the compliant domain (102). The list may e.g. be issued, maintained, etc. by revocation/authorization list maintenance means (107), e.g. located at a trusted third party. Additionally, this list may also be centrally maintained in a home network as part of a home network security system. This list then indicates what import devices are allowed at home. If such a home network or home domain also has an ID this ID could also be attached to the content in a signature.

A use device, system, application (denoted use device in the following) (104) used for playback, access, recording, rendering and/or in general any other suitable use of the imported content material (100′) is also shown.

According to the present invention, a check is performed in the use device (104) prior to use of the content material (100′) whether an attached or related unique identifier (105), e.g. the serial number for the importing device, of a content material (100′) exists in the revocation list (106) or in an authorization (white) list, and disable the use of the content material (100) if this is the case. In this way, no imported content (100′) may be used if it has been imported by an import device that has been determined to import content material illegally into the compliant domain (102). In this way, all content imported by a particular import device is rendered unusable in a very simple and efficient manner even if it is determined if that particular import device has imported content material illegally only once. Additionally, if a representation of a time stamp and/or sequence number was attached or related to the imported content revocation of content may e.g. limited to content that was imported after a certain date, etc.

Alternatively, the revocation list (106) is in a positive form, i.e. a authorization list/a ‘white’-list (106), and the use device (104) checks if the unique identifier/serial number exists in the list in order to allow the use of the content material. A unique identifier of a import device that has been determined to be used illegally is then removed from the list.

The revocation or authorization list is preferably stored in each use device (104) for rapid access and may be updated from a central location either periodically or upon change e.g. under the control of a trusted third party.

Preferably, additional checks are made in order to increase the security further. These checks may comprise a check for the existence and presence of screening information and a check of whether the screening information indicates that the given use is to be permitted, e.g. if play-back, access, rendering, copy-once, copy-many, etc. of the content material is allowed according to certain rights. Additionally, a check of the digital signature over the screening information using the unique certificate (105) is performed. This may be done using the public key, belonging to the private/public key pair of the device used to import the content material, being part of the certificate (105). These checks may be performed before or after the check of a unique identifier in the authorization/revocation list, database, etc.

A use device (104) may be an import device (103) with use functionality or other devices without import facility and only use facility.

Additionally, if an imported content material (100′) is to be used in a use device (104) for recording the content to a suitable medium it may be preferred to attach or relate a unique identifier, like a serial number, of the recording device as part of the signature of the recorded content material during the actual recording. In this way, it is also possible to identify which device made an actual copy of an imported content material, and thereby refuse illegal content material that would normally be considered legal due to the presence in the compliant domain (102) in a very simple and efficient manner.

FIG. 3 illustrates a schematic block diagram of a importing/screening device/application according to the present invention. Shown is content material (100) still in the non-compliant domain. Screening information is obtained/derived (302) in order to determine the rights associated with the content material like whether it is to be allowed into the compliant domain, playback rights, etc. The screening information may e.g. be obtained/determined by detecting for the presence of one or more watermarks in the content material (100) or according to other protecting schemes. The screening information relates to the rights with respect to the uses of the content material (100).

A hash function is applied (303) to at least a part of the content material (100). The screening information and the derived hash value(s) is then digitally signed (304) by a private key of a public/private key pair being unique to the screening/importing device (103) resulting, if everything is ‘ok’, in a content material (100′) in the compliant domain. The calculation of at least one hash value makes the signature dependent on the actual (complete or part thereof) content. Alternatively, other secure one-way, check-sum, fingerprint schemes, etc. may be used instead of or in combination with a hash function. In this way, the identity of the importing device (103) used is related to the specific content material (100) during import via the signature and/or the public/private key pair. Alternatively, a unique identifier may be comprised in the content material (100′), e.g. by adding one or more watermarks describing/containing the unique identifier. Additionally, a representation of a time stamp and/or sequence number may be attached or related (303) to the imported content in a similar manner as for the unique import device id number/serial number. This may be used to limit revocation to content that was imported after a given time, date, etc. Preferably, the content material is also encrypted by encryption means (not shown) in order to prevent it from leaking into in the non-compliant domain.

The schematic blocks 302-304 (and the encryption means) is preferably implemented by at least one general and/or specialized purpose processing unit.

In this way, it is possible to identify the screening/importing device/application (103) that was used to import a given content material (100′) which may advantageously be used if it is determined that a given content material was imported illegally in a very efficient and simple manner.

FIG. 4 illustrates a use device/application according to the present invention, e.g. a DVD player/recorder, etc. for recording and/or playing back imported content material (100′) e.g. an MPEG encoded bit stream. The content material (100′) may be recorded/stored on an information medium like a DVD disc, etc. or be accessible via network, memory and/or storage means (not shown). The content material (100′) is applied to an output terminal (403) via a switch circuit (402). The output terminal (403) is connected to an external suitable decoder, if necessary, and a display device (not shown). The switch circuit (402) is preferably controlled by a control circuit or processing unit (404) that performs a check of whether the content material (100′) was imported by a importing/screening device, application, system, etc. that has been determined to import illegal content into the compliant domain using a revocation (or authorization) list and refuses the use of such content material (100′).

Preferably, other checks are performed by the control/processing circuit like the ones described earlier by checking that the screening information states that a given right to the use exists and that the signature over the screening information using the unique (public key of the) screening/importing device/application certificate. If either of these two checks fails then use of the content material (100′) is preferably also refused. Additionally, the use device (104) may also comprise means (either specialized means and/or the control/processing unit (404)) for decrypting the content material (100′) if it is in an encrypted format in order to prevent if from being used in the non-compliant domain. Further, if a representation of a time stamp and/or sequence number is attached or related to the imported content, this may be used to enable check for revocation that was imported after a given time, date, etc. only.

If the use device (104) is used for recording the content material (100′) on a medium the unique serial number/identifier may be attached or related to the recorded content in a similar way.

FIGS. 5a and 5b illustrate examples of formats for a revocation and an authorization list, respectively. Shown in FIG. 5a is an exemplary format for a revocation list (106). The list (106) comprises a number of unique identifiers, e.g. a serial number, for importing/screening devices/applications that have been revoked. In one embodiment, the list (106) may further comprise for each identifier, a date, e.g. in the form of a time-stamp or sequence number, indicating preferably when the given screening device/application has been revoked. Alternatively, the time-stamp or sequence number may be available by other means than the list (106), i.e. this information does not exist in the list (106) but is available from another source (or not at all for some embodiments).

FIG. 5b illustrates an exemplary format for an authorization list (106), which comprises a number of unique identifiers, e.g. a serial number, for importing/screening devices/applications that have been granted authorization to import content material into the compliant domain. In one embodiment, the list (106) may further comprise for each identifier, a date, e.g. in the form of a time-stamp or sequence number, indicating preferably until when the given screening device/application has been authorized. Alternatively, the time-stamp or sequence number may be available by other means than the list (106), i.e. this information does not exist in the list (106) but is available from another source (or not at all for some embodiments).

If a time-stamp or serial number is attached or related to content material during import as described elsewhere, a switch-circuit (like 402 in FIG. 4) may disable use of content if the time-stamp/serial number is after a time-stamp/higher than the serial number (for increasing serial numbers) of the entry of the unique screening device or screening application identifier in an authorization list (106), or after a time-stamp/higher than the serial number of the entry of said unique screening device or screening application identifier in a revocation list (106).

Alternatively, other formats for the revocation/authorization list may be used. An authorization list may e.g. comprise a date specifying when the authorization is valid from, etc. As another alternative, the revocation/authorization list may simply comprise the unique identifiers thereby specifying only if a given import device/application is revoked/authorized. The above-mentioned check would then have to be changed accordingly.

In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device and/or system claim enumerating several means, several of these means can be embodied by one and the same item of hardware. The mere fact that certain measures are recited in mutually different dependent claims does no indicate that a combination of these measures cannot be used to advantage.

In summary, a unique identifier of an importing/screening device is attached or related to content material during import from a non-compliant domain into a compliant domain. In this way, it is always possible to identify the importing device for a given content material. A list comprising unique identifiers for importing devices that has been determined to import content material illegally may then be used in devices, applications, systems, etc. for the using content material in such a way that the use may be prohibited for content material being imported in to the compliant domain by devices, applications, systems, etc. that has been determined to import content material illegally.

This allows for the revocation of use of content material in the compliant domain that has been imported there by an importing/screening device that has been determined to illegally import content material.

1. A method of enabling revocation or authorization of screened content material (100′) screened by a screening device (103) or a screening application (103), the method comprising the step of:
attaching or relating a unique screening device or application identifier (105) to content material (100) during import of the content material (100) from a non-compliant domain (101) into a compliant domain (102),
where the identifier (105) uniquely identifies the screening device (103) or the screening application (103) used to import said content material (100).

2. Method according to claim 1, characterized in that said method further comprises the step of generating and/or maintaining a revocation list (106) comprising a unique identifier (105) for at least one screening device or application (103) that has been determined to illegally import content material (100) into the compliant domain (102).

3. Method according to claim 2, characterized in that the method further comprises the step of
checking in a use device or application (104) prior to use of a screened content material (100′) whether said attached or related unique screening device or application identifier (105) exists in said revocation list (106), and disable the use of the screened content material (100′) if this is the case.

4. Method according to claim 1, characterized in that the method further comprises the steps of:
generating and/or maintaining an authorization list (106) comprising a unique identifier (105) for at least one screening device or application (103) that has been granted authorization to import content material (100) into the compliant domain (102), and
checking in a use device or application (104) prior to use of a screened content material (100′) whether said attached or related unique screening device or application identifier (105) of a content material (100) exists in said authorization list (106), and disable use of the content material (100′) if this is not the case.

5. Method according to claim 1, characterized in that the step of attaching or relating said unique identifier (105) comprises:
obtaining screening information,
obtaining additional information being dependent on at least part the content material (100), and
digitally signing the screening information and additional information, resulting in a digital signature, that uniquely identifies the screening device (103) or application (103) used to import said content material (100).

6. Method according to claim 5, characterized in that said additional information comprises a result of a hash function performed on at least a part of said content material (100).

7. Method according to claim 5, characterized in that said additional information comprises a result of a digital fingerprint function performed on at least a part of said content material (100).

8. Method according to claim 5, characterized in that the method further comprises one or more steps of:
checking said content material (100′) for the existence of said screening and additional information, and
checking for a correct digital signature over said screening information,
where the steps of checking are performed prior to use of the content material (100′) by a use device or application (104), and where said use is prevented if at least one check is not met.

9. Method according to claim 5, characterized in that said unique identifier (105) comprises at least a public key of a screening device (103) or screening application (103), which is signed by a trusted authority.

10. Method according to claim 5, characterized in that a unique identifier (105) of a recording device (104) is attached or related to a copy of the screened content material (100′) when the content material is recorded after import into the compliant domain (102).

11. Method according to claim 5, characterized in that said additional information includes:
a representation of a time-stamp, and that a use of said screened content (100′) is disabled only if said time-stamp is
after a time-stamp of the entry of said unique screening device or screening application identifier (105) in an authorization list (106), or
after a time-stamp of the entry of said unique screening device or screening application identifier (105) in a revocation list (106).

12. A system for enabling revocation or authorization of screened content material (100′) by a screening device (103) or a screening application (103), wherein
the screening device or application (103) comprises means (302, 303, 304) for attaching or relating a unique screening device or application identifier (105) to the content material (100) during import of the content material (100) from a non-compliant domain (101) into a compliant domain (102),
where the identifier (105) uniquely identifies the screening device (103) or the screening application (103) used to import said content material (100).

13. A system according to claim 12, characterized in that said system further comprises means (107) for generating and/or maintaining a revocation list (106) comprising a unique identifier (105) for at least one screening device or application (103) that has been determined to illegally import content material (100) into the compliant domain (102).

14. A system according to claim 13, characterized in that the system further comprises a use device or application (104) adapted to
check, prior to use of a screened content material (100′), whether said attached or related unique screening device or application identifier (105) exists in said revocation list (106), and disable the use of the screened content material (100′) if this is the case.

15. A system according to claim 12, characterized in that the system further comprises:
means (107) for generating and/or maintaining an authorization list (106) comprising a unique identifier (105) for at least one screening device or application (103) that has been granted authorization to import content material (100) into the compliant domain (102), and
a use device or application (104) adapted to check, prior to use of a screened content material (100′), whether said attached or related unique screening device or application identifier (105) of a content material (100) exists in said authorization list (106), and disable the use of the content material (100′) if this is not the case.

16. A system according to claim 12, characterized in that said means (302, 303, 304) for attaching or relating said unique identifier (105) comprises:
means (302) for obtaining screening information,
means (303) for obtaining additional information being dependent on at least a part the content material (100), and means (304) for digitally signing the screening information and additional information, resulting in a digital signature, that uniquely identifies the screening device (103) or application (103) used to import said content material (100).

17. A system according to claim 16, characterized in that said additional information comprises a result of a hash function performed on at least a part of said content material (100) and/or a result of a digital fingerprint function performed on at least a part of said content material (100).

18. A system according to claim 16, characterized in that said use device or application (104) further is adapted, prior to use of a screened content material (100′), to:
check said content material (100′) for the existence of said screening and additional information, and
check for a correct digital signature over said screening information
where said use is prevented if at least one check is not met.

19. A system according to claim 16, characterized in that said unique identifier (105) comprises at least a public key of a screening device (103) or screening application (103), which is signed by a trusted authority.

20. A system according to claim 16, characterized in that said system further comprises means (302, 303, 304) attaching or relating a unique identifier (105) of a recording device (104) to a copy of the screened content material (100′) when the content material is recorded after import into the compliant domain (102).

21. A system according to claim 14, characterized in that said additional information includes:
a representation of a time-stamp, and that a use of said screened content (100′) is disabled only if said time-stamp is
after a time-stamp of the entry of said unique screening device or screening application identifier (105) in a authorization list (106), or
after a time-stamp of the entry of said unique screening device or screening application identifier (105) in a revocation list (106).

22. A screening device (103) for enabling revocation or authorization of screened content material (100′), wherein
the screening device comprises means (302, 303, 304) for attaching or relating a unique screening device or application identifier (105) to the content material (100) during import of the content material (100) from a non-compliant domain (101) into a compliant domain (102),
where the identifier (105) uniquely identifies the screening device (103) used to import said content material (100).

23. A use device (104) adapted to
check, prior to a use of a screened content material (100′), what use right a unique screening device or application identifier (105) attached or related to said content material (100′) signifies, and process said screened content material (100′) according to said use right, where
the content material (100′) is imported by a screening device (103) adapted to attach or relate a unique screening device or application identifier (105) to the content material (100) during import of the content material (100) from a non-compliant domain (101) into a compliant domain (102).

24. A device according to claim 23, characterized in that said device is adapted to perform said check according to:
checking whether said identifier (105) exists in a revocation list (106), and disable said use of the screened content material (100′) if this is the case, where
the revocation list (106) comprises a unique identifier (105) for at least one screening device or application (103) that has been determined to illegally import content material (100) into the compliant domain (102).

25. A device according to claim 23, characterized in that said device is adapted to perform said check according to:
checking whether said identifier (105) exists in an authorization list (106), and disable use of the content material (100′) if this is not the case, where
the authorization list (106) comprises a unique identifier (105) for at least one screening device or application (103) that has been granted authorization to import content material (100) into the compliant domain (102).

26. A computer readable medium having stored thereon instructions for causing one or more processing units to execute the method according to claim 1.
